(19) United States
(12) Patent Application Publication
(10) Pub. No.: US 2003/0147648 A1
(43) Pub. Date: Aug. 7, 2003

(54) Arrangement for producing a wavelength-multiplex signal having small interchannel spaces

(76) Inventor: Harald Bock, Augsburg (DE)

Correspondence Address: BELL, BOYD & LLOYD, LLC, P. O. BOX 1135, CHICAGO, IL, 60690-1135, US

(21) Appl. No.: 10/220,788

(22) PCT Filed: Feb. 28, 2001
(86) PCT No.: PCT/DE01/00741

(30) Foreign Application Priority Data
Mar. 3, 2000 (DE) 100 10 453.3

(51) Int. Cl. H04J 14/02

(52) U.S. Cl. 398/82

(57) ABSTRACT

Several wavelength multiplexers (WM1, WM2) to which optical signals (KS11-KS1n; KS21-KS2n) are supplied are interconnected by an optical coupler. Said optical signals (KS11-KS1n; KS21-KS2n) are interleaved in order to form wavelength-multiplex signal (WMS). The wavelength multiplexers (WM1, WM2) have double channel bandwidths in relation to a multiplexer used to produce the wavelength multiplex signal (WMS) in a single stage so that the quality of the optical signals (KS11-KS1n; KS21-KS2n) is not reduced through the limitation of their spectra.

The invention is directed to a method for generating wavelength multiplex signals.

In optical systems, data having high data rates are transmitted with the assistance of the wavelength multiplex method. 40 Gbit/s are desired as channel data rates; the data rates will be higher in the future. On the transmissions side, a number of optical individual signals are combined to a wavelength multiplex signal via optical filters, are transformed into data pulses, are transmitted and are subsequently divided again into individual signals on the reception side. Given a conventional channel spacing of 100 GHz and transmission rates of 40 Gbit/s, the signal quality is already impaired not only with respect to the multiplexer on the transmission side but also with respect to the demultiplexer on the reception side since the spectrum is limited as a result of the limited filter bandwidths given the RZ format (return to zero) of the data pulses, in particular.

German Patent 4209790 A1 discloses a multi-step switching equipment for optical signals which couples a number of optical signals by means of a frequency layer converter. A signal having a specific operating wavelength is respectively supplied to the inputs of the frequency layer converters. Every frequency layer converter is able to convert the supplied signal into one operating wavelength dependent on the driving, whereby a number of operating wavelengths are prescribed. A combination of an optoelectrical converter and an adjustable laser or the aforementioned Y-laser can be used as a frequency layer converter. Therefore, wavelengths of a signal can be converted onto [sic] other wavelengths. A combination of a number of signals having different wavelengths, given a reduction of the channels spaces with a minimized impairment of the signal quality, is not mentioned here.

U.S. Pat. No. 5,748,350 discloses an arrangement for generating a wavelength multiplex signal with a low channel spacing wherein a circulator combines signals having great wavelength distances, from at least two wavelength multiplexers, into [sic] a wavelength multiplex signal having low wavelength distances. Given the arrangement having two wavelength multiplexers, one of the connections has a series of Bragg filters between a first wavelength multiplexer and a circulator, whereby reflections from the signals outputted from the second wavelength multiplexer can be filtered by said Bragg filters.

Therefore, an object of the invention is to propose an arrangement for generating a wavelength multiplex signal having a low channel spacing, whereby the quality is only slightly effected. The arrangement is to be fashioned such that it only has a relatively low attenuation.

This object is achieved by an arrangement according to claim 1.

Claim 2 provides an advantageous embodiment of the invention.

The arrangement can be cost-efficiently realized with a relatively low outlay, it requires only minimal space and generates a multiplex signal whose individual signals are not impaired as a result of a limited bandwidth. This arrangement can only be used on the transmission side on the transmission side [sic].

This object is achieved by an arrangement according to claim 1.

Claim 2 provides an advantageous embodiment of the invention.

The arrangement can be cost-efficiently realized with a relatively low outlay, it requires only minimal space and generates a multiplex signal whose individual signals are not impaired as a result of a limited bandwidth. This arrangement can only be used on the transmission side on the transmission side [sic].

A FIGURE explains an inventive exemplary embodiment in greater detail.

The inventive exemplary embodiment shown in the FIGURE contains two wavelength multiplexers WM1 and WM2 whose outputs are connected to the inputs of an optical coupler KO.

The wavelength multiplexers WM1 and WM2 are realized as a filter arrangement, which determine channel spaces, whereby the transmission bands [or: pass-ranges] correspond to the channel bandwidths. A group of modulated optical signals (individual signals) KS11 to KS1 n or, respectively, KS21 to KS2n are respectively supplied to the inputs of the wavelength multiplexers WM1 and WM2—in the RZ format, for example, whereby the frequency spacing or channel spacing of 200 GHz of said group of modulated optical signals is twice as much as the channel spacing of 100 GHz of the wavelength multiplex signal WMS at the output of the arrangement. The first wavelength multiplexer WM1 combines the signals KS11 to KS1n to a first intermediate signal ZS1 (wavelength multiplex signal having twice as much channel spacing), and the second wavelength multiplexer WM2 combines the signals KS21 to KS2n to a second intermediate signal ZS2.

Both intermnediate signals ZS1 and ZS2 are combined, in the coupler KO, to the desired wavelength multiplex signal WMS, whereby the signals KS11 to KS1n and KS21 to KS2n of both intermediate signals are interlaced with one another. A condition therefor is that the carrier frequencies (medium frequencies) of the optical signals KS11 to KS1n are offset, vis-á-vis the signals KS21 and KS2n, by the channel spacing KAM of the wavelength multiplex signal WMS and the channels of the wavelength multiplexers certainly are also fashioned correspondingly.

The wavelength multiplexers WM1 and WM2 correspond to filter arrangements which are dimensioned corresponding to the spectrum of the modulated optical signals KS11 to KS1n and KS21 to KS2n, namely dependent on the data rate and modulation (dependentonthepulseduration given RZ pulses). The bandwidth of each channel of the wavelength multiplexer is always selected such that it is greater than the bandwidth of the appertaining demultiplexer on the reception side. Said bandwidth is selected such that the spectrum is not limited or, respectively, such that its influence on the signal quality is negligible. Given a filter arrangement forming the wavelength multiplexer as shown in the exemplary embodiment, 200 GHz filters are concerned (this corresponds to the channel spacing KAE of the intermediate signals) since they have twice as much bandwidth as a multiplexer which is necessary for a single-stage generation of the wavelength multiplex signal. Given a pulse duty factor of 0.3 of the optical signals, a dimensioning of the filters is beneficial which has an additional attenuation of 1 dB given approximately ±60 GHz deviation (corresponds to one third of the channel spacing of the multiplexer) from the medium frequency. The optical coupler KO does not have any band-limiting properties.

More than two wavelength multiplexers and a coupler with the corresponding greater number of inputs can also be used for forming the wavelength multiplex signal. The carrier frequencies of the individual signals or, respectively, the medium frequencies of the channels, then, are offset by the corresponding frequency spacing of the wavelength multiplex signal. However, since the attenuation of the coupler increases with the number of inputs, a beneficial compromise is to be made with respect to the formation of the arrangement which takes the channel spacing, the channel bandwidth of the wavelength multiplexers, the number of wavelength multiplex [. . . ] and the attenuation of the optical coupler into consideration. Given correspondingly offset channel grids [or: rasters], two or more of the arrangements shown in the Figure can also be cascaded via a further coupler.

Furthermore, amplifying, attenuating or frequency-dependent elements can be switched between the wavelength multiplexers and the coupler inputs.

1. Arrangement for generating a wavelength multiplex signal (WMS) having low channel spaces with a plurality of M (m=2, 3, . . . ) wavelength multiplexers (WM1, WM2, . . . WMm), whereby optical signals (KS11 to KS1n; KS21 to KS2n; . . . ; KSm1 to KSmn), whose channel spaces (KAE) respectively correspond to the m^{th} channel spacing (KAM) of the wavelength multiplex signal (WMS) and whose transmission bands are offset by the channel spacing (KAM) of the wavelength multiplex signal (WMS), are supplied, in a group, to said wavelength multiplexers, and the use of an optical coupler (KO) whose inputs are connected [. . .] outputs of the wavelength multiplexers (WM1, WM2, . . . , WMm) for generating the wavelength multiplex signal (WMS), characterized in that
the transmission bands of the wavelength multiplexers (WM1, WM2, . . . , WMm) have a greater bandwidth than the ones of a pertaining demultiplexer on the receive side and are fashioned in a broadband manner such that a limitation of the spectrum of the optical signals (KS11 to KS1n; KS21 to KS2n; . . . ; KSm1 to KSmn), which are respectively supplied to them in a group, only negligibly impairs the signal quality.

2. Arrangement according to claim 1, characterized in that
two wavelength multiplexers (WM1, WM2) and an optical coupler (KO) having 2inputs are provided.

3. Arrangement according to claim 1 or 2, characterized in that
the additional attenuation of a wavelength multiplexer (WM1, WM2) approximately is 1 dB given a deviation from the medium frequency of a transmission channel, which corresponds to one third of the spacing of its transmission bands.

4. Arrangement according to one of the previous claims, characterized in that
wavelength multiplexer (WM1, WM2) are provided whose channels spectrally have maximum transmission bands.
